(19) United States
(12) Patent Application Publication
(10) Pub. No.: US 2026/0061365 A1
(43) Pub. Date: Mar. 5, 2026

(54) PURIFICATION SYSTEM

(71) Applicant: ISUZU MOTORS LIMITED, Yokohama-shi (JP)

(72) Inventors: Ryusuke FUJINO, Fujisawa-shi (JP); Hisashi OZAWA, Fujisawa-shi (JP); Teppei OHORI, Fujisawa-shi (JP)

(21) Appl. No.: 19/307,072

(22) Filed: Aug. 22, 2025

(30) Foreign Application Priority Data
Sep. 4, 2024 (JP) 2024-152455

(51) Int. Cl. B01D 53/34; B01D 53/86; B01D 53/90

(52) U.S. Cl. CPC B01D 53/343; B01D 53/8668; B01D 53/8696; B01D 53/90; B01D 2251/104; B01D 2255/20746; B01D 2255/50; B01D 2257/7025; B01D 2258/06; B01D 2259/4566; B01D 2259/65

(57) ABSTRACT

A purification system has: a flow path section where a to-be-purified gas containing methane flows; a supply section that is provided in the flow path section, and supplies ozone to the to-be-purified gas; and a radiator that is provided downstream of the supply section in the flow path section, and performs heat exchange between the to-be-purified gas and a heat transfer medium that cools a heat source, in which the radiator has a catalyst that purifies the methane in the gas under an ozone atmosphere.

### CROSS-REFERENCE TO RELATED APPLICATIONS

The present application claims priority to Japanese Patent Application No. 2024-152455, filed on Sep. 4, 2024, contents of which are incorporated herein by reference in their entirety.

### BACKGROUND OF THE INVENTION

The present invention relates to a purification system that purifies methane. There is a known catalyst that decomposes methane, which is an air pollutant, under an ozone atmosphere. Japanese Unexamined Patent Application Publication (Translation of PCT Application) No. 2021-505376 discloses a technology to purify methane by heating a gas containing methane and ozone to 100° C. or higher using a heating section, and thereafter bringing the gas into contact with a catalyst in which iron is supported on silica, zeolite, or the like.

However, in the technology in Japanese Unexamined Patent Application Publication (Translation of PCT Application) No. 2021-505376, it is necessary to heat the gas containing methane and ozone to a predetermined temperature using the heating section. Accordingly, energy is consumed for heating the gas containing methane and ozone.

### BRIEF SUMMARY OF THE INVENTION

The present invention has been made in view of these matters, and an object thereof is to reduce consumed energy during methane purification.

An aspect of the present invention provides a purification system having: a flow path section where a gas containing methane flows; a supply section that is provided in the flow path section, and supplies ozone to the gas; and a radiator that is provided downstream of the supply section in the flow path section, and performs heat exchange between the gas and a heat transfer medium that cools a heat source, in which the radiator has a catalyst that purifies the methane in the gas under an ozone atmosphere.

### BRIEF DESCRIPTION OF THE DRAWINGS

FIG. 1 is a drawing for explaining the configuration of a purification system.

FIG. 2 is a schematic diagram of a radiator.

FIG. 3 is an enlarged schematic diagram of part of the radiator.

FIG. 4 is a drawing for explaining a methane purification rate.

FIG. 5 is a flowchart depicting an example of a methane purification process.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### <Configuration of Purification System S>

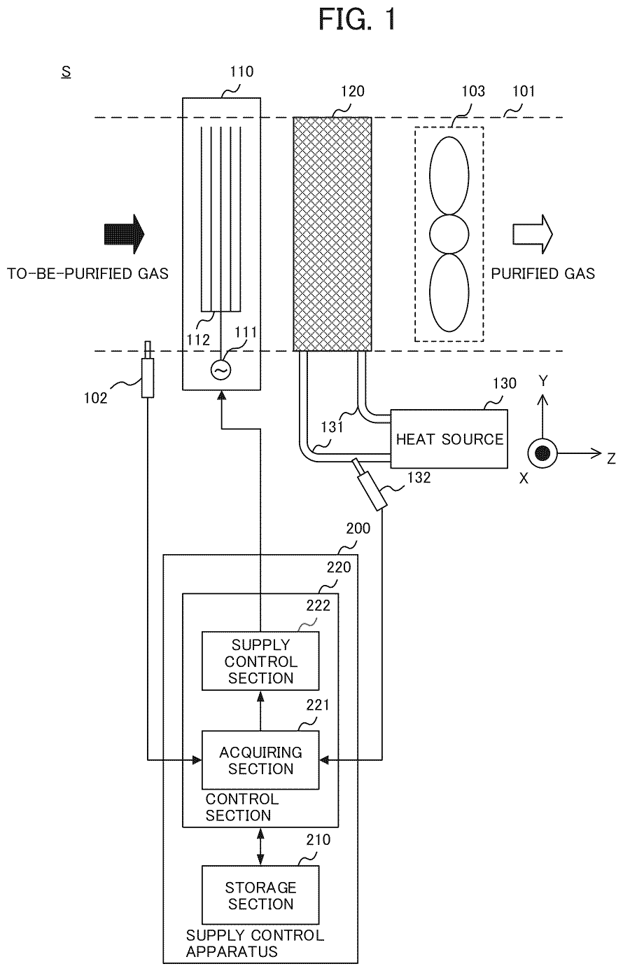

FIG. 1 is a drawing for explaining the configuration of a purification system S. For example, the purification system S is provided on a vehicle or a ship having mounted thereon a heat source 130 such as an engine. The purification system S has a flow path section 101, a methane sensor 102, an intake section 103, a supply section 110, a radiator 120, the heat source 130, a heat transfer medium circuit 131, a temperature sensor 132, and a supply control apparatus 200. The purification system S decomposes methane to generate water and nitrogen dioxide by adding ozone to a gas containing methane and causing ozone and methane to react on a catalyst. In the following explanation, decomposing methane to generate water and nitrogen dioxide is referred to as purifying methane in some cases.

A to-be-purified gas containing methane flows in the flow path section 101. For example, the to-be-purified gas is atmospheric air. In a case where the purification system S is provided on a vehicle, the flow path section 101 is surrounded by other apparatuses provided in an engine room. In other words, the flow path section 101 is a gap formed by other apparatuses provided in the engine room.

The methane sensor 102 is provided in the flow path section 101. The methane sensor 102 senses the amount of methane in the to-be-purified gas at predetermined time intervals. For example, the predetermined time intervals are 100 milliseconds, but are not limited to this. For example, the methane sensor 102 senses the methane concentration of the to-be-purified gas as the amount of methane. Each time the methane sensor 102 senses the methane concentration, the methane sensor 102 outputs the sensed methane concentration to the supply control apparatus 200.

The intake section 103 is provided in the flow path section 101. For example, the intake section 103 is an intake air fan. The intake section 103 draws in the to-be-purified gas into the flow path section 101. The intake section 103 is provided downstream of the methane sensor 102 in the flow path section 101. In FIG. 1, the intake section 103 draws in the to-be-purified gas such that the to-be-purified gas flows in the flow path section 101 in the z direction from the left side to the right side on the paper surface.

The supply section 110 is provided between the methane sensor 102 and the intake section 103 in the flow path section 101. The supply section 110 supplies ozone to the to-be-purified gas. For example, the supply section 110 has an AC power supply 111 and electrodes 112 covered with a dielectric such as glass. The supply section 110 executes a process of generating ozone by causing the AC power supply 111 to apply an AC voltage to the electrodes 112 (so-called silent discharge method). The supply section 110 may generate ozone by executing a process of causing discharge on the surface of a dielectric covering the electrodes 112 (so-called creeping discharge method), a process of electrolyzing water (so-called electrolysis method), or a process of emitting ultraviolet rays onto the to-be-purified gas (so-called ultraviolet lamp method).

The radiator 120 is provided downstream of the supply section 110 in the flow path section 101. The radiator 120 is provided between the supply section 110 and the intake section 103 in the flow path section 101. The radiator 120 is provided downstream of the heat source 130 in the heat transfer medium circuit 131 where a heat transfer medium that cools the heat source 130 flows. The radiator 120 performs heat exchange between the heat transfer medium and the to-be-purified gas. The radiator 120 cools the heat source 130 by supplying, to the heat source 130, the heat transfer medium having been cooled through heat exchange with the to-be-purified gas. For example, the heat transfer medium is water or ethylene glycol, but is not limited to these.

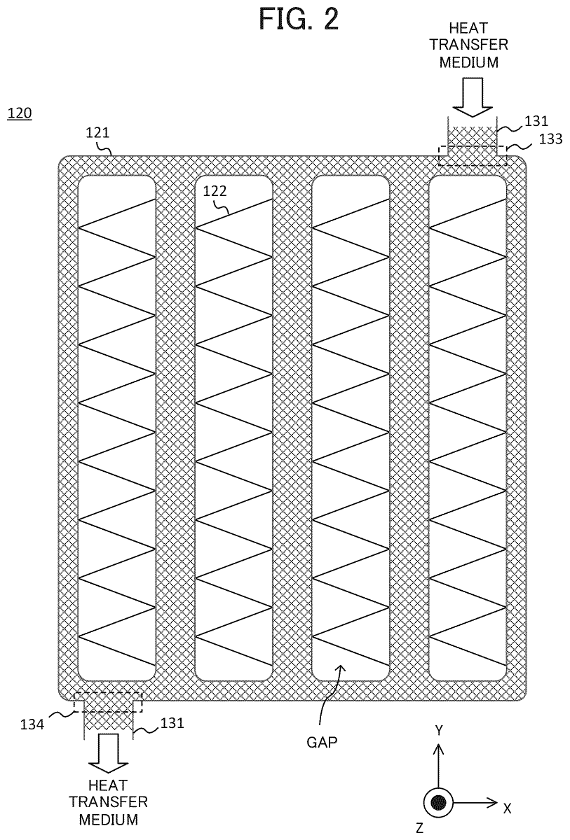

FIG. 2 is a schematic diagram of the radiator 120. The radiator 120 has a plurality of pipes 121 and a plurality of heat dissipation fins 122. The pipes 121 are lines where the heat transfer medium flows. The pipes 121 are connected to the heat transfer medium circuit 131 at a connection point 133 and a connection point 134. Specifically, the pipes 121 are connected by the connection point 133 to the heat transfer medium circuit 131 positioned downstream side of the heat source 130, and are connected by the connection point 134 to the heat transfer medium circuit 131 positioned upstream of the heat source 130.

The pipes 121 are provided such that the heat transfer medium flows in the horizontal direction (x direction) and the vertical direction (y direction). The heat transfer medium discharged from the heat source 130 enters the pipe 121 at the connection point 133, flows in the horizontal direction (x direction), and enters the plurality of pipes 121. The heat transfer medium flows in each pipe 121 in the y direction from the upper side toward the lower side. Whereas there are five pipes 121 where the heat transfer medium flows in the y direction from the upper side toward the lower side in the present embodiment, the number of the pipes may be equal to or greater than six or equal to or smaller than four. The heat transfer medium exits the pipes 121 at the connection point 134, passes through the heat transfer medium circuit 131, and enters the heat source 130.

Each of the plurality of heat dissipation fins 122 is connected to pipes 121. Each heat dissipation fin 122 is provided to connect two pipes 121. The respective heat dissipation fins 122 are provided to allow the to-be-purified gas to pass between each pair of heat dissipation fins 122. Gaps are provided between the respective heat dissipation fins 122 and the respective pipes 121. The gaps are areas surrounded by the heat dissipation fins 122 and the pipes 121. When the heat transfer medium flows through the pipes 121, heat of the heat transfer medium moves to the heat dissipation fins 122, and heat exchange occurs between the to-be-purified gas flowing through the gaps and the heat dissipation fins 122. The radiator 120 is a so-called corrugated-type radiator, but may be another type of radiator.

For example, the heat source 130 is an engine. The engine combusts and expands an air-fuel mixture of fuel and intake air (air) to generate motive power. For example, the engine is a diesel engine mounted on an automobile, but may be a gasoline engine. Note that the heat source 130 only has to be an apparatus that needs to be cooled, and is not necessarily an engine. For example, the heat source 130 may be a motor, a fuel cell, or a storage battery, and it is sufficient if the heat source 130 is an apparatus that is cooled using the radiator 120.

The temperature sensor 132 is a sensor that detects the temperature of the heat transfer medium. The temperature sensor 132 has its leading end inserted into the heat transfer medium circuit 131, and detects the temperature of the heat transfer medium flowing through the heat transfer medium circuit 131. The temperature sensor 132 outputs the detected temperature of the heat transfer medium to the supply control apparatus 200.

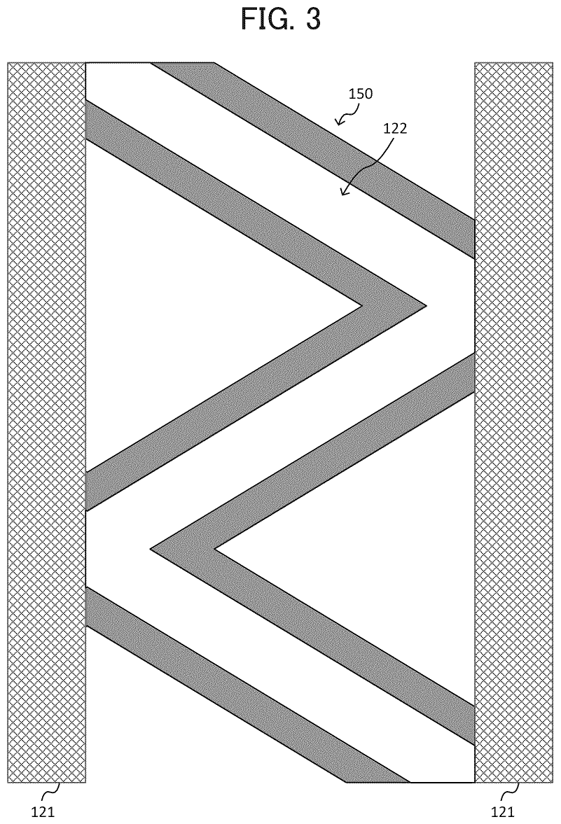

A catalyst 150 is provided in the radiator 120. For example, the catalyst 150 is provided on the surfaces of the pipes 121 of the radiator 120 and/or the surfaces of the heat dissipation fins 122 of the radiator 120. FIG. 3 is an enlarged schematic diagram of part of the radiator 120. In FIG. 3, the catalyst 150 is depicted in dark gray. The catalyst 150 is provided on the surfaces of the heat dissipation fins 122. Specifically, the catalyst 150 is provided on both surfaces of the heat dissipation fins 122 so as to cover the surfaces of the heat dissipation fins 122. Note that the surfaces of the heat dissipation fins 122 may include areas not covered with the catalyst 150.

The catalyst 150 purifies methane in the to-be-purified gas under an ozone atmosphere. The catalyst 150 purifies methane by promoting a reaction between ozone and methane on the surface of the catalyst 150, thereby decomposing methane into water and carbon dioxide. For example, the catalyst 150 contains a zeolite, an iron ion-exchanged zeolite, and/or a cobalt ion-exchanged zeolite. The catalyst 150 is not limited to these, but only has to be a catalyst that can purify methane under an ozone atmosphere.

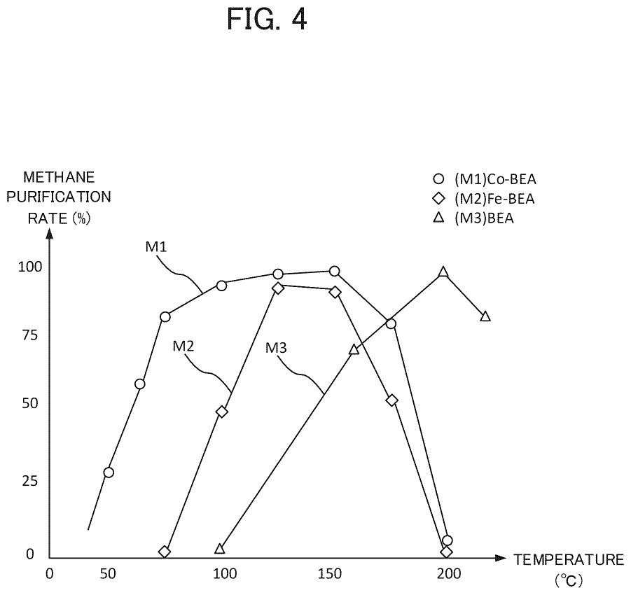

The methane purification rate of the catalyst 150 changes according to the temperature. FIG. 4 is a drawing for explaining the methane purification rate. The horizontal axis of FIG. 4 represents the temperature of the catalyst 150 (equivalent to the temperature of the heat transfer medium), and the vertical axis of FIG. 4 represents the methane purification rate. FIG. 4 depicts a catalyst M1, a catalyst M2, and a catalyst M3 as types of the catalyst 150. The catalyst M1 is a cobalt ion-exchanged zeolite (Co-BEA) in which cobalt is supported on a β-type framework zeolite. The catalyst M2 is an iron ion-exchanged zeolite (Fe-BEA) in which iron is supported on a β-type framework zeolite. The catalyst M3 is a β-type framework zeolite (BEA). As depicted in FIG. 4, no matter whether the type of the catalyst 150 is any of the catalyst M1, the catalyst M2, and the catalyst M3, the methane purification rate increases as the temperature increases in a case where the temperature is lower than 150° C.

Since the catalyst 150 is provided in the radiator 120, the catalyst 150 is heated by heat of the radiator 120. In other words, due to heat having moved from the heat source 130 to the radiator 120 via the heat transfer medium, the purification system S can heat the catalyst 150 to the same temperature as the temperature of the heat transfer medium. Thereby, the purification system S can heat the catalyst 150 using heat of the heat source 130 without heating the catalyst 150 using a heater or the like. As a result, the purification system S can reduce consumed energy during methane purification as compared to a case where the catalyst 150 is heated using a heater or the like.

Note that, as depicted in FIG. 4, the purification rate of the catalyst 150 lowers when its temperature increases excessively. However, in a case where the heat transfer medium is water or ethylene glycol, the temperature of the heat transfer medium does not become higher than 120° C. Accordingly, the purification rate of the catalyst 150 is not lowered by an excessive increase of the temperature of the catalyst.

Meanwhile, in a case where the amount of methane contained in the to-be-purified gas is large, a larger amount of ozone needs to be supplied. In addition, if ozone is supplied in a case where methane is not contained in the to-be-purified gas, energy is wasted undesirably.

In view of this, the supply control apparatus 200 controls the amount of ozone to be supplied to the to-be-purified gas according to the amount of methane contained in the to-be-purified gas. Hereinbelow, the configuration of the supply control apparatus 200 is explained. The supply control apparatus 200 has a storage section 210 and a control section 220. The storage section 210 is a storage medium including a ROM (Read Only Memory), a RAM

(Random Access Memory), a hard disk, and the like. The storage section 210 stores programs to be executed by the control section 220.

For example, the control section 220 is a computational resource including a processor such as a CPU (Central Processing Unit). By executing programs stored on the storage section 210, the control section 220 realizes functions as an acquiring section 221 and a supply control section 222.

The acquiring section 221 acquires the methane concentration sensed by the methane sensor 102. Each time the methane sensor 102 senses the methane concentration, the acquiring section 221 acquires the methane concentration from the methane sensor 102. In addition, the acquiring section 221 acquires the temperature of the catalyst 150. Since the temperature of the catalyst 150 approximately matches the temperature of the heat transfer medium, the acquiring section 221 may acquire the temperature of the heat transfer medium sensed by the temperature sensor 132 as the temperature of the catalyst 150. The acquiring section 221 outputs the acquired methane concentration and the acquired temperature of the heat transfer medium to the supply control section 222.

The supply control section 222 controls the amount of ozone to be supplied to the to-be-purified gas. In a case where the supply section 110 supplies ozone to the to-be-purified gas by discharge, the supply control section 222 changes the voltage and/or frequency of an AC voltage that the AC power supply 111 applies to the electrodes 112 of the supply section 110. Specifically, as the methane concentration increases, the supply control section 222 increases the amount of ozone to be supplied to the to-be-purified gas by increasing the voltage and/or frequency of the AC voltage that the AC power supply 111 applies to the electrodes 112.

In a case where the temperature of the catalyst 150 is equal to or higher than a predetermined temperature, the supply control section 222 supplies ozone to the to-be-purified gas. Specifically, in a case where the temperature of the heat transfer medium acquired as the temperature of the catalyst 150 by the acquiring section 221 is equal to or higher than the predetermined temperature, the supply control section 222 supplies ozone to the to-be-purified gas. The predetermined temperature is a temperature at which the methane purification rate representing the amount of methane that the catalyst 150 can purify becomes equal to or higher than a predetermined value. For example, the predetermined value is 50%, and is desirably 80%. In a case where the catalyst is a cobalt ion-exchanged zeolite (see M1 in FIG. 4), the temperature at which the methane purification rate becomes 50% is 60° C., and the temperature at which the methane purification rate becomes 80% is 75° C. That is, in a case where the catalyst 150 is the catalyst M1, the supply control section 222 starts supplying ozone to the to-be-purified gas when the temperature of the heat transfer medium has become equal to or higher than 75° C. Thereby, in a case where the catalyst 150 can sufficiently purify methane, the supply control section 222 can supply ozone. As a result, the supply control section 222 can use energy efficiently.

In a case where the temperature of the heat transfer medium is lower than the predetermined temperature, the supply control section 222 does not supply ozone to the to-be-purified gas. In other words, in a case where the methane purification rate of the catalyst 150 is lower than the predetermined value because the temperature of the heat transfer medium is low, and the catalyst 150 has not been heated, the supply control section 222 does not supply ozone to the to-be-purified gas. In one specific example, in a case where the catalyst 150 is the catalyst M1, the supply control section 222 does not supply ozone to the to-be-purified gas when the temperature of the heat transfer medium is lower than 75° C. Thereby, the supply control section 222 can reduce energy waste since the supply control section 222 does not supply ozone in a case where the methane purification rate of the catalyst 150 is low.

In a case where the methane concentration of the to-be-purified gas is equal to or higher than a threshold, the supply control section 222 supplies ozone to the to-be-purified gas. For example, the threshold is a lower limit value at which the methane sensor 102 can sense methane. In a case where the methane concentration is equal to or higher than the threshold, the supply control section 222 increases the amount of ozone to be supplied to the to-be-purified gas as the methane concentration increases. Specifically, as the methane concentration increases, the supply control section 222 increases the amount of ozone to be supplied to the to-be-purified gas by increasing the frequency and/or voltage value of an AC voltage to be applied to the electrodes 112 of the supply section 110. By doing so, the supply control section 222 can increase the amount of ozone to be supplied to the to-be-purified gas as the amount of methane contained in the to-be-purified gas increases. As a result, it becomes easier for ozone and methane to react on the catalyst 150, and the methane purification rate is enhanced.

In a case where the methane concentration is lower than the threshold, the supply control section 222 does not supply ozone to the to-be-purified gas. Thereby, the supply control section 222 can reduce energy waste since the supply control section 222 does not supply ozone to the to-be-purified gas in a case where the amount of methane contained in the to-be-purified gas is so small that the methane sensor 102 cannot sense methane.

The supply control section 222 may supply ozone to the to-be-purified gas depending on the operational state of the heat source 130. For example, the supply control section 222 starts supplying ozone after the engine, which is the heat source 130, has started operating. Specifically, the supply control section 222 does not supply ozone to the to-be-purified gas while the temperature of the heat transfer medium is lower than the predetermined temperature after an operation start of the engine. In a case where the temperature of the heat transfer medium has become equal to or higher than the predetermined temperature after an operation start of the engine, the supply control section 222 starts supplying ozone to the to-be-purified gas. Thereby, in a case where the catalyst 150 has been heated, and is in a state where the catalyst 150 can sufficiently purify methane, the supply control section 222 can supply ozone to the to-be-purified gas. As a result, the supply control section 222 can efficiently use energy for methane purification.

Meanwhile, the state where the temperatures of the engine, which is the heat source 130, the heat transfer medium, and the catalyst 150 are high continues also for a while after an operation stop of the engine. In view of this, the supply control section 222 continues supplying ozone to the to-be-purified gas until the temperature of the heat transfer medium becomes lower than the predetermined temperature after an operation stop of the engine. In this case, the intake section 103 continues drawing in the to-be-purified gas. By doing so, the catalyst 150 can purify methane even after the operation stop of the engine.

In a case where the temperature of the heat transfer medium has become lower than the predetermined temperature after the operation stop of the engine, the supply control section 222 stops supplying ozone to the to-be-purified gas. The supply control section 222 stops the intake section 103 after the supply of ozone to the to-be-purified gas is stopped. Thereby, the supply control section 222 can reduce energy waste since the supply control section 222 can prevent ozone from being supplied in a case where the temperature of the catalyst 150 has lowered, and the methane purification rate has lowered.

### [Methane Purification Process]

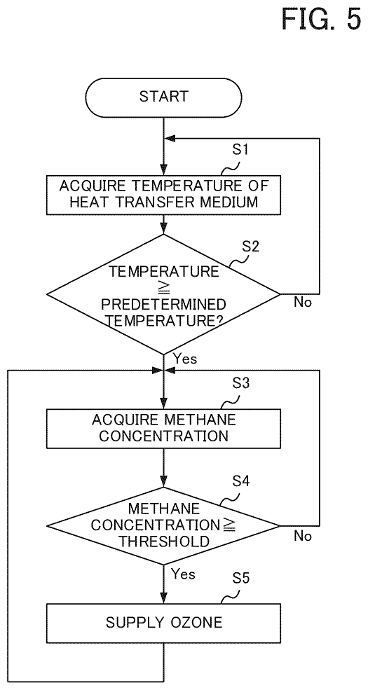

FIG. 5 is a flowchart depicting an example of a methane purification process. For example, the methane purification process is executed after an operation start of the engine, which is the heat source 130.

The acquiring section 221 acquires the temperature of the heat transfer medium (Step S1). Specifically, the acquiring section 221 acquires the temperature of the heat transfer medium detected by the temperature sensor 132. The supply control section 222 determines whether or not the temperature of the heat transfer medium is equal to or higher than the predetermined temperature (Step S2). In a case where the temperature of the heat transfer medium is lower than the predetermined temperature (No at Step S2), the supply control section 222 returns to Step S1, and waits until the temperature of the heat transfer medium becomes equal to or higher than the predetermined temperature.

In a case where the temperature of the heat transfer medium is equal to or higher than the predetermined temperature (Yes at Step S2), the acquiring section 221 acquires the methane concentration (Step S3). Specifically, the acquiring section 221 acquires the methane concentration detected by the methane sensor 102.

The supply control section 222 determines whether or not the methane concentration is equal to or higher than the threshold (Step S4). In a case where the methane concentration is lower than the threshold (No at Step S4), the supply control section 222 returns to Step S3, and waits until the methane concentration becomes equal to or higher than the threshold.

In a case where the methane concentration is equal to or higher than the threshold (Yes at Step S4), the supply control section 222 supplies ozone to the to-be-purified gas (Step S5). For example, the supply control section 222 increases the amount of ozone to be supplied to the to-be-purified gas as the methane concentration increases. The supply control section 222 of the supply control apparatus 200 repeats the processes from Step S1 to Step S5 until the engine is stopped.

In a case where the engine has stopped operating, the supply control section 222 supplies ozone to the to-be-purified gas until the temperature of the heat transfer medium becomes lower than the predetermined temperature. In a case where the temperature of the heat transfer medium has become lower than the predetermined temperature, the supply control section 222 stops supplying ozone to the to-be-purified gas.

### [Effects of Purification System S]

As explained above, the purification system S has: the flow path section 101 where the to-be-purified gas containing methane flows; the supply section 110 that is provided in the flow path section 101, and supplies ozone to the to-be-purified gas; and the radiator 120 that is provided downstream of the supply section 110 in the flow path section 101, and performs heat exchange between the heat transfer medium that cools the heat source 130 and the to-be-purified gas. The radiator 120 has the catalyst 150 that purifies methane in the to-be-purified gas under an ozone atmosphere.

In the purification system S, as the temperature of the radiator 120 rises due to heat of the heat source 130, the catalyst 150 is heated, and the temperature of the catalyst 150 rises. In this manner, the purification system S can heat the catalyst 150 without using a heater or the like for heating the catalyst 150. Since the methane purification rate is enhanced as the temperature of the catalyst 150 rises, the purification system S can purify methane more efficiently. Furthermore, since the purification system S heats the catalyst 150 using heat of the heat source 130, the purification system S can reduce consumed energy during methane purification in atmospheric air as compared to a case where a heater is used for heating the catalyst 150.

Whereas the present invention has been explained using embodiments thus far, the technical scope of the present invention is not limited by the scope described in the embodiments described above, but various modifications and changes are possible within the scope of a gist of the present invention. For example, all or some of apparatuses can be configured functionally or physically distributed or integrated in any units. In addition, new embodiments that are generated by any combination of a plurality of embodiments are also included in embodiments of the present invention. Effects of the new embodiments generated by the combination combine effects of the original embodiments.

What is claimed is:

1. A purification system comprising:
a flow path section where a gas containing methane flows;
a supply section that is provided in the flow path section, and supplies ozone to the gas; and
a radiator that is provided downstream of the supply section in the flow path section, and performs heat exchange between the gas and a heat transfer medium that cools a heat source, wherein
the radiator has a catalyst that purifies the methane in the gas under an ozone atmosphere.

2. The purification system according to claim 1, wherein the radiator has the catalyst on a surface of a heat dissipation fin of the radiator and/or a surface of a line where the heat transfer medium flows.

3. The purification system according to claim 1, wherein the catalyst contains a cobalt ion-exchanged zeolite.

4. The purification system according to claim 1, wherein the supply section supplies the ozone to the gas in a case where temperature of the heat transfer medium is equal to or higher than a predetermined temperature, and does not supply the ozone to the gas in a case where the temperature is lower than the predetermined temperature.

5. The purification system according to claim 1, wherein the supply section supplies the ozone to the gas in a case where concentration of the methane in the gas is equal to or higher than a threshold, and does not supply the ozone to the gas in a case where the concentration is lower than the threshold.

6. The purification system according to claim 1, wherein the supply section increases an amount of the ozone to be supplied to the gas as concentration of the methane in the gas increases.

7. The purification system according to claim 1, wherein
the supply section
starts supplying the ozone to the gas in a case where temperature of the heat transfer medium has become equal to or higher than a predetermined temperature after an operation start of an engine which is the heat source; and
continues supplying the ozone to the gas until the temperature of the heat transfer medium becomes lower than the predetermined temperature after an operation stop of the engine.

8. The purification system according to claim 1, wherein the flow path section is surrounded by another apparatus provided in an engine room of a vehicle on which an engine which is the heat source is mounted.

9. The purification system according to claim 1, comprising:
an intake section that draws in the gas into the flow path section, wherein
the intake section is provided downstream of the radiator in the flow path section.

10. The purification system according to claim 4, wherein the predetermined temperature is a temperature at which an amount of the methane that the catalyst can purify becomes equal to or greater than a predetermined value.
